(19) United States
(12) Patent Application Publication
(10) Pub. No.: US 2007/0024402 A1
(43) Pub. Date: Feb. 1, 2007

(54) Apparatus for inspecting conveyed works

(75) Inventors: Tadashi Hanaoka, Mie (JP); Shuichi Maruyama, Mie (JP); Toshirou Higuma, Mie (JP)

Correspondence Address: BIRCH STEWART KOLASCH & BIRCH, PO BOX 747, FALLS CHURCH, VA, 22040-0747, US

(73) Assignee: HONDA MOTOR CO., LTD.

(21) Appl. No.: 11/495,526

(22) Filed: Jul. 31, 2006

(30) Foreign Application Priority Data
Aug. 1, 2005 (JP) 2005-223459

(51) Int. Cl. H01H 73/12

(52) U.S. Cl. 335/17

(57) ABSTRACT

An apparatus for inspecting conveyed works includes a plurality of inspection lines, each of which includes plural kinds of inspection units and a conveyor unit configured to convey the works to each inspection unit one after another. Certain inspection units are commonly used by the inspection lines.

### BACKGROUND OF THE INVENTION

The present invention relates to an apparatus for inspecting conveyed works, which conveys the works so as to undergo a plurality of inspection processes.

Generally speaking, it is a common practice that a work such as a connecting rod, which requires plural kinds of inspections, is subjected to the inspections before its shipment (see patent document 1). More specifically, in the pre-shipment inspection, the work is usually rested manually on inspection units one after another. In this connection, an apparatus is known, which has inspection units combined with a unit for machining works (see patent document 2). In this apparatus, an inspection per lot (certain number of works) has been usually carried out so as to save time in processing.

Patent document 1: Japanese Published Patent Application 2000-304028 (paragraph 0025 and FIG. 6)

Patent document 2: Japanese Published Patent Application 2001-105212 (paragraph 0122 and FIG. 4)

However, a manual inspection has a drawback that it is time-consuming. An inspection conducted for a work immediately after its machining has also a drawback that if a defect is found out, works which have not completed the inspections have to be reinspected, thereby requiring time and labor. In contrast, if a facility is built, which is able to conduct a plurality of inspection processes on one inspection line, it can save time but costs too much.

### SUMMARY OF THE INVENTION

In view of the drawbacks described above, the present invention provides an apparatus for inspecting conveyed works, which is able not only to conduct inspection of the works in a short period of time but also to contribute to a reduction in manufacturing costs.

It is an aspect of the present invention to provide an apparatus for inspecting conveyed works, which includes a plurality of inspection lines, each of which includes plural kinds of inspection units and a conveyor unit configured to convey the works to each inspection unit one after another. Certain inspection units are commonly used by the inspection lines.

Because a work carried by the conveyor unit sequentially undergoes the inspections one after another conducted by the plural kinds of inspection units, which results in an intensive line of inspection processes, it is possible to reduce time required for inspecting the works. Furthermore, because the certain inspection units are commonly used by the inspection lines, it is possible to reduce manufacturing costs. In this connection, there are methods for sharing an inspection unit. For example, one method is that certain inspection units are shuttled between inspection lines to be described later. Another method is that a work resting on an inspection line is transferred to a certain inspection unit so as to undergo an inspection and subsequently returned to the inspection line.

It is another aspect of the present invention to provide an apparatus for inspecting conveyed works further including a transfer unit. While an inspection is being conducted by a most time-consuming inspection unit, the transfer unit carries less time-consuming inspection units, each of which requires a shorter period of time for inspection than the most time-consuming inspection unit, to each inspection line so that certain inspection units are commonly used by inspection lines.

When there are two inspection lines, for example, less time-consuming inspection units, which have completed inspections on a first inspection line where an inspection with a most time-consuming inspection unit is being conducted, are transferred to a second inspection line so that the less time-consuming inspection units are used on the second inspection line. In this way, it is possible not only to efficiently spend time in waiting for completion of the most time-consuming inspection, but also to have the inspection lines share the less time-consuming inspection units, which results in a reduction in manufacturing costs.

It is still another aspect of the present invention to provide an apparatus for inspecting conveyed works, in which the works are connecting rods, a most time-consuming inspection unit is a unit for measuring weight of each connecting rod and less time-consuming inspection units are a unit for measuring inner diameters of a big-end hole and a small-end hole of each connecting rod and a unit for measuring pitches of the big-end hole and the small-end hole.

While a connecting rod is undergoing weight measurement conducted by the unit for measuring weight, the unit for measuring inner diameters and the unit for measuring pitches, which have completed measurement on a first inspection line, are transferred to a second inspection line so that they are used on it. In this way, it is possible not only to efficiently spend time in waiting for completion of processing conducted by the unit for measuring weight, but also to reduce manufacturing costs.

It is yet another aspect of the present invention to provide an apparatus for inspecting conveyed works, further including for each inspecting line a unit for inserting pin which inserts an attachment component into a small-end hole so as to remove burrs thereof and verifies a mating condition between the small-end hole and the attachment component.

Because the attachment component is inserted into the small-end hole of the connecting rod, it is possible not only to remove its fine burrs but also to provide an inspection to verify whether or not the attachment component fits into the small-end hole (whether or not the small-end hole is complete-round, for example). This results in an increase in accuracy of quality and inspection accuracy of a work. It should be noted that as a result of increasing the accuracy of quality for the small-end hole of the connecting rod, there is a merit that it is possible to smoothly conduct a stricter assembly process subsequent to the inspection process.

### BRIEF DESCRIPTION OF THE DRAWINGS

FIG. 1 is a plan view showing an apparatus for inspecting conveyed works according to the present invention.

FIG. 2 is a side view showing an apparatus for inspecting conveyed works according to the present invention.

FIG. 3A is a plan view showing inspection lines shown in FIG. 1, mainly a table unit.

FIG. 3B is a side view showing inspection lines shown in FIG. 1, mainly a conveyor unit.

FIG. 3C is a sectional view taking along line X-X of FIG. 3B.

FIG. 4 is a front view showing a unit for loading work.

FIG. 5 is a side view showing a unit for loading work.

FIG. 6A is a schematic diagram illustrating connecting rods set for a process P1.

FIG. 6B is a schematic diagram illustrating weight measurement of a connecting rod.

FIG. 6C is a schematic diagram illustrating measurement for inner diameter of a connecting rod.

FIG. 6D is a schematic diagram illustrating movement of a unit.

FIG. 6E is a schematic diagram illustrating a unit returned to an original inspection line.

### DESCRIPTION OF THE PREFERRED EMBODIMENTS

An embodiment of the present invention is now described with reference to the drawings.

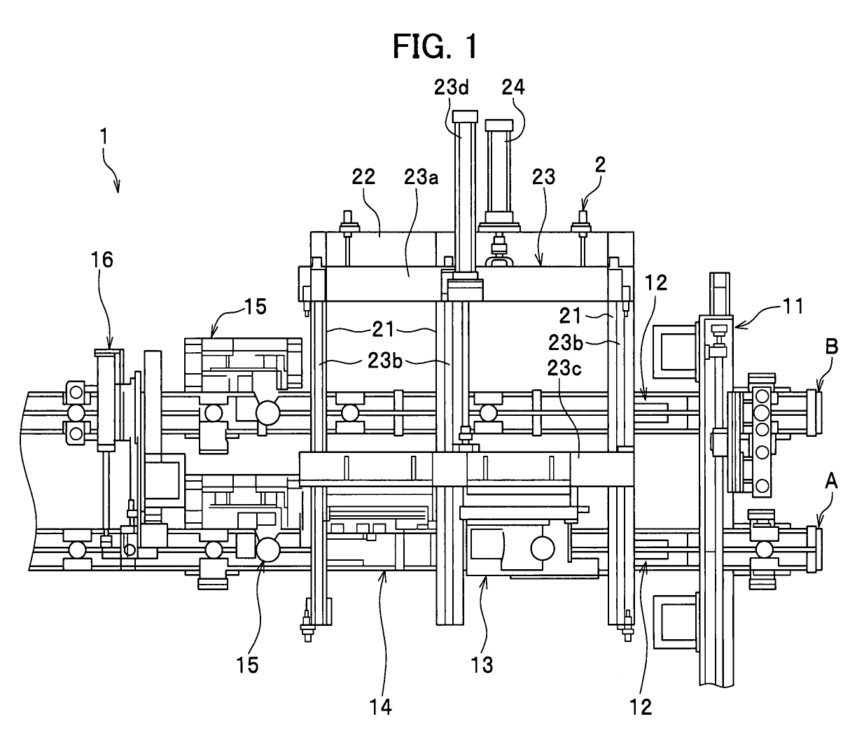

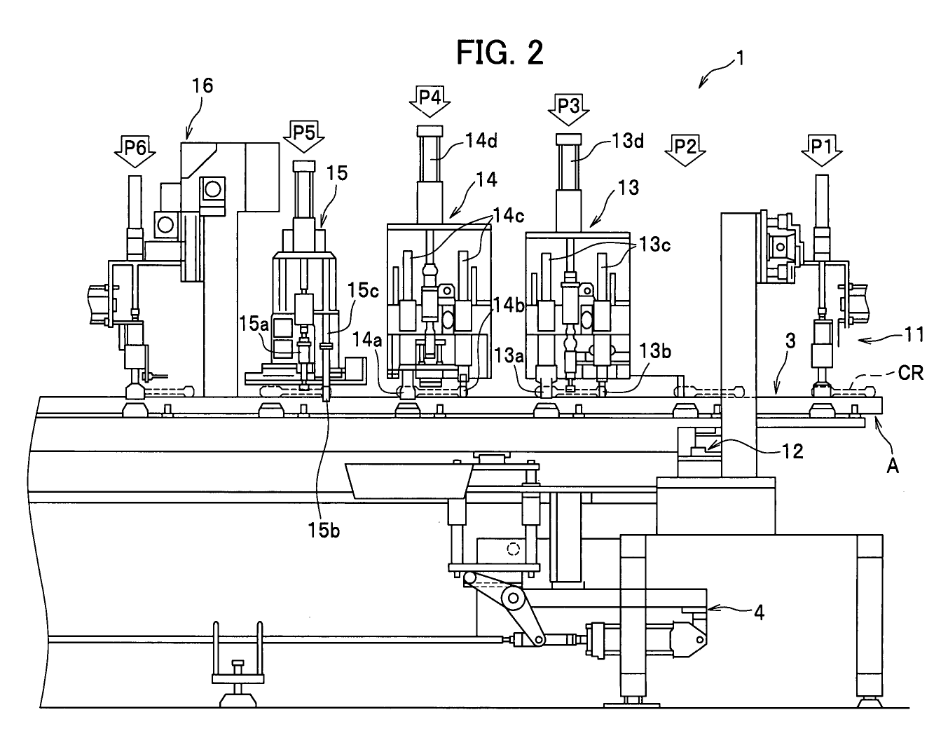

As shown in FIGS. 1 and 2, an apparatus 1 for inspecting conveyed works has two inspection lines A and B, each of which provides plural processes of inspection for connecting rods (works) CR. The apparatus 1 includes a unit 11 for loading work, a unit 12 for measuring weight, a unit 13 for measuring inner diameter, a unit 14 for measuring pitch, a unit 15 for inserting pin, a unit 16 for unloading work and the like, which are disposed from upstream to downstream of the inspection lines A and B. Among these units, the unit 11 and the unit 16 are commonly used by the inspection lines A and B. Also the unit 13 and the unit 14, which are carried by a transferring unit 2, are commonly used by the inspection lines A and B.

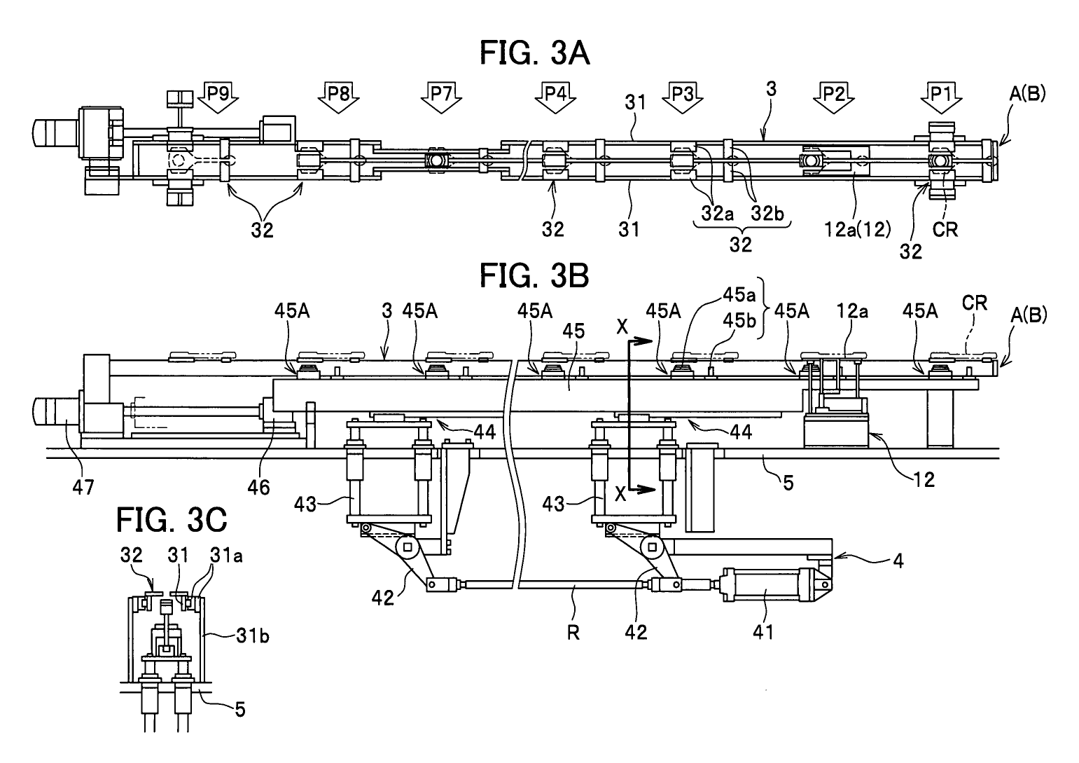

As shown in FIGS. 3A and 3B, the inspection lines A and B each have a table unit 3 and a conveyor unit 4. It should be noted that the length of the table unit 3 is determined so that it provides a sufficient space to conduct inspections and the like in processes P1 to P9 (see FIG. 2).

As shown in FIG. 2, the process P1 corresponds to setting of a connecting rod CR on the table unit 3, the process P2 measurement of its weight and the process P3 measurement of its inner diameter. The process P4 corresponds to measurement of pitches of a big-end hole and a small-end hole of the connecting rod CR. The big-end hole is a hole located in an end portion where the connecting rod CR has a larger dimension. On the other hand, the small-end hole is a hole located in the other end portion on the opposite side having a smaller dimension. The process 5 corresponds to insertion of a pin into the small-end hole. The process P6 corresponds to removal of connecting rods CR from the lines through a chute, which are found to have defects. As shown in FIG. 3A, the process P7 corresponds to marking of ranks for the diameters of the connecting rod CR. The process P8 corresponds to laser marking of a manufactured date and the like. The process P9 corresponds to delivery of good works, which have passed each inspection, out of the inspection lines.

The table unit 3 includes two frames 31 in long length, which are disposed parallel to each other, and support plates 32, which are provided at regular pitches (conveying pitches) in a longitudinal direction of the frames 31. As shown in FIG. 3C, a frame 31 is secured to a base 5 via members 31a, 31b and the like. As shown in FIG. 3A, on the other had, a support plate 32 includes a big-end support 32a and a small-end support 32b, which extend inward from each frame 31. It should be noted that support of the connecting rod CR provided by the support plate 32 as described above is given in different manners in some processes. In the process P2 for measuring weight, a measurement base 12a of the unit 12 for measuring weight is used instead. In the process P7 for marking of ranks for the diameters of the connecting rod CR, a distance between the frames 31 is partially decreased so that the frames 31 support the connecting rod CR instead of the big-end supports 32a of the support plate 32.

The conveyor unit 4 includes a rod R, a cylinder 41, a swing arm 42, a piston 43, a sliding mechanism 44, a vertically movable stand 45, a movable nut 46, a motor 47 and the like. The cylinder 41 provides longitudinal movement for the rod R in a substantially horizontal direction. The swing arm 42 swings according to the longitudinal movement of the rod R. The piston 43 vertically moves in response to swinging of the swing arm 43. The vertically movable stand 45 is coupled to the piston 43 via the sliding mechanism 44. The movable nut 46 not only allows the vertical stand 45 to vertically move, but also horizontally moves in unison with the vertical stand 45. The motor 47 provides horizontal movement for the movable nut 46. The vertically movable stand 45 has eight pieces of supports 45A corresponding to eight processes. Each support 45A includes a pin 45a which engages with a big-end hole and a pin 45b which supports a shank of a connecting rod CR. After elevating the vertical stand 45 by the cylinder 41 and the motor 47, the conveyor unit 4 advances the vertical stand 45 by a distance corresponding to one process and lowers it so as to convey a connecting rod CR to a subsequent process. After this operation, the conveyor 4 drives the vertical stand 45 in reverse so as to restore it to the original position. Repeating this sequence, the conveyor unit 4 sequentially carries a connecting rod CR from a process to another process (P2→P3→ . . . →P9). It should be noted that in this embodiment there is a predetermined difference in timing of conveyance between a conveyor 4 of the inspection line A and a conveyor 4 of the inspection line B, which allows the inspection lines A and B to alternately convey connecting rods CR.

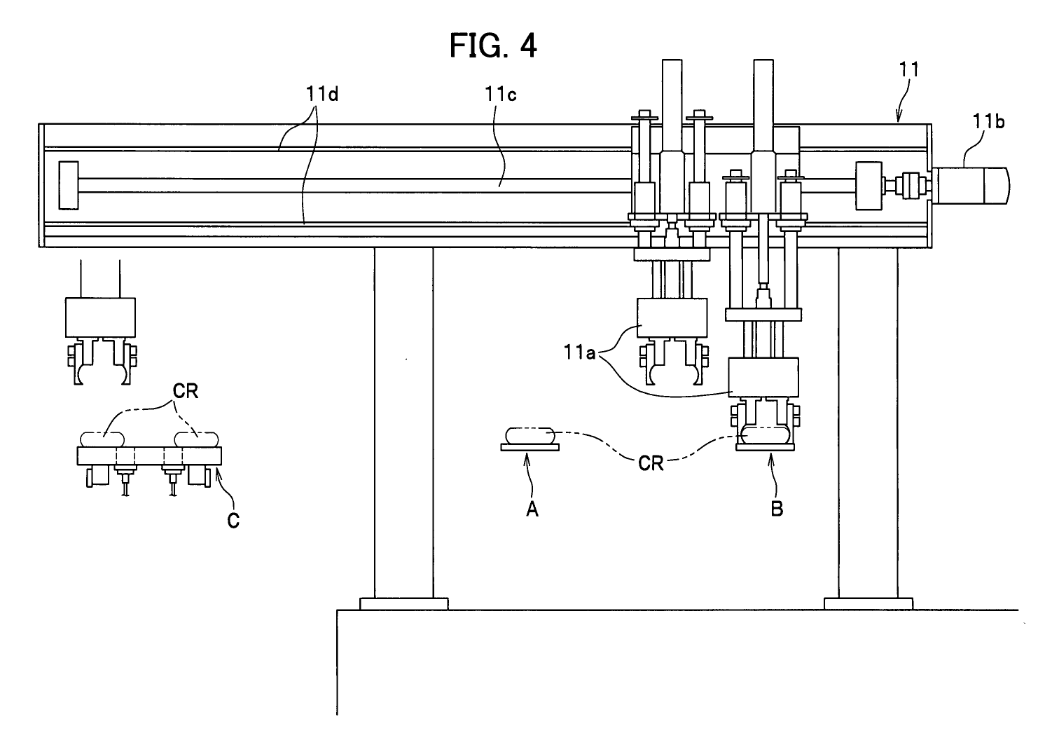

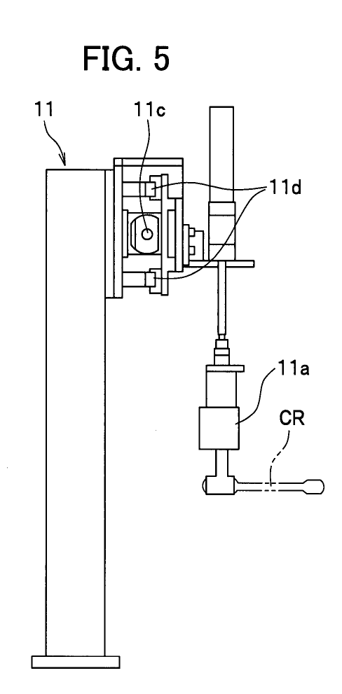

As shown in FIGS. 1 and 2, receiving them from other lines, the unit 11 for loading work, which is used in the process P1, rests connecting rods CR to be inspected one after another on the inspection lines A and B. As shown in FIGS. 4 and 5, the unit 11 includes a pair of chuck arms 11a, a motor 11b, a ball bolt 11c and a pair of rails 11d. Each chuck arm 11a has a function of vertical movement and picking up a connecting rod CR. The motor 11b horizontally drives the pair of chuck arms 11a. The unit 11 simultaneously picks up two pieces of connecting rods CR, which are on another line C, by the pair of chuck arms 11a, so that the unit 11 rests these connecting rods CR on the inspection lines A and B one after another.

As shown in FIG. 3B, the unit 12 for measuring weight (most time-consuming inspection unit), which is used in the process P2, has the measurement base 12a on which a connecting rod CR carried from the process P1 is rested so as to measure its weight. It should be noted that since the measurement is conducted with a tolerance of about 2 grams, the process P2 requires the longest period of time among the processes P1 to P9. Tact time for the conveyor unit 4 (time period between completion of conveyance and a start of the subsequent conveyance) is determined according to (not less than) the time required by the weight measurement.

As shown in FIG. 2, the unit 13 for measuring inner diameter (less time-consuming inspection unit), which is used in the process P3, includes inspection heads 13a and 13b, a pair of rails 13c and a cylinder 13d. The inspection heads 13a and 13b blow air against inner surfaces of a big-end hole and a small-end hole of a connecting rod CR, respectively. The cylinder 13d simultaneously moves the inspection heads 13a and 13b along the pair of rails 13c extending vertically. The unit 13 inserts the inspection heads 13a and 13b into the big-end hole and small-end hole of the connecting rod CR respectively, which is carried from the process P2 so as to blow air against their inner surfaces. An inner diameter of each hole is measured based on resultant parameters such as a back pressure, which varies depending on a distance between a hole of an inspection head for blowing air and an inner surface. It should be noted that the unit 13, which is able to complete measurement by blowing air against the inner surfaces of the holes with the inserted inspection heads 13a and 13b which have certain clearances with respect to the holes, allows an inspection time shorter than the weight measurement described above (process P2).

The unit 14 for measuring pitch (less time-consuming inspection unit), which is used in the process P4, includes inspection heads 14a and 14b, a pair of rails 14c and a cylinder 14d, in a similar manner as the unit 13 for measuring inner diameter. The inspection heads 14a and 14b blow air against inner surfaces of a big-end hole and a small-end hole of a connecting rod CR, respectively. The cylinder 14d simultaneously moves the inspection heads 14a and 14b along the pair of rails 14c extending vertically. The unit 14 inserts the inspection heads 14a and 14b into the big-end hole and small-end hole of the connecting rod CR respectively, which is carried from the process P3 so as to blow air against their inner surfaces. A pitch of each hole is measured based on resultant parameters, a back pressure for example and a pitch of each of the inspection heads 14a and 14b. It should be noted that the unit 14, which introduces an air micrometer similar to the unit 13, allows an inspection time shorter than the weight measurement described above (process P2).

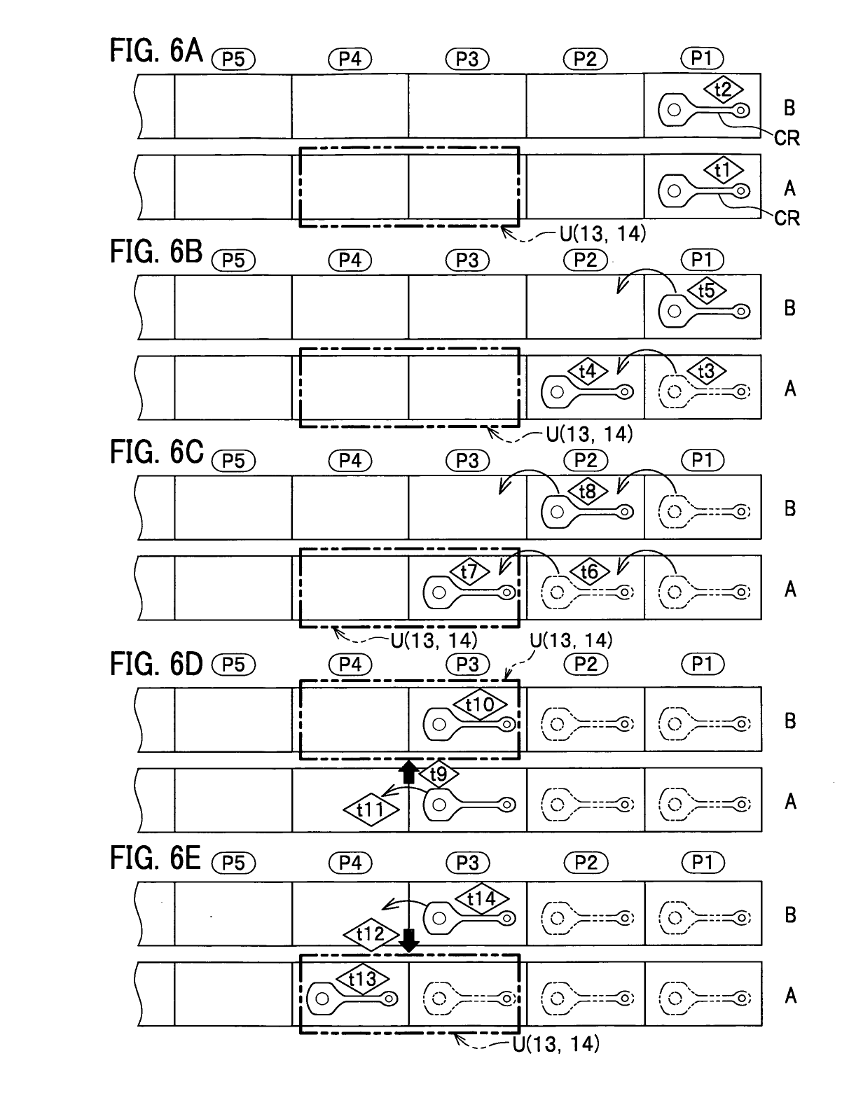

As shown in FIG. 1, the transferring unit 2 includes three base frames 21 shaped like arches and a fixed base 22, which form a base structure, and a sliding mechanism 23. Each base frame 21 straddles the inspection lines A and B. The fixed base 22 is secured to an end and upper portion of each base frame 21. The sliding mechanism 23 is disposed on the base structure. The sliding mechanism 23 includes a fixed member 23a, three guide rails 23b, a slider 23c, a cylinder 23d and the like. The fixed member 23a bridges the three base frames 21 and is secured to them. The three guide rails 23b extend along the three base frames 21 from the fixed member 23a, respectively. The slider 23c is freely movable along the guide rails 23b on the base frames 21. The cylinder 23d, which is secured to the fixed member 23a, provides movement for the slider 23c. The slider 23c, to which the unit 13 for measuring inner diameter and the unit 14 for measuring pitch are secured, allows the units 13 and 14 to shuttle as one unit U (see FIG. 6A) between the inspection lines A and B. In this connection, an adjustment cylinder 24 is attached to the fixed base 22. The adjustment cylinder 24 mates the inspection heads 13a, 13b, 14a and 14b of the units 13 and 14 with a master gauge, which is disposed outside of the inspection line A, by shifting the whole sliding mechanism 23 to an end of the base frames 21 (opposite to the fixed base 22).

As shown in FIG. 2, the unit 15 for inserting pin, which is used in the process P5, includes a chuck unit 15a, a pin 15b, a press fitting unit 15c and the like. The chuck unit 15 holds a connecting rod CR. The press fitting unit 15c inserts the pin 15b, which is similar to an actual component, into a small-end hole of the connecting rod CR. The press fitting unit 15c not only verifies a mating condition between the small-end hole and the pin 15b (roundness of the small-end hole) by inserting the pin 15b into the small-end hole, but also removes fine burrs within the small-end hole by press fitting the pin 15b.

When a work is found to have defects (reinspection is necessary) in the processes P2 to P5, the unit 16 for unloading work receives NG information. The unit 16, which is used in the process P6, is able to reject the work with defects from an inspection line through a chute so as to have the work undergo a reinspection based on the NG information.

Description is given of operation of the apparatus 1 for inspecting conveyed works with reference to FIGS. 6A to 6E. It should be noted that it is assumed that no works have been loaded on the inspection lines A and B, when their operation has not been started.

As shown in FIG. 6A, one of two connecting rods CR held by the unit 11 for loading work (see FIG. 4) is rested on the inspection line A (time t1). Subsequently, the other connecting rod CR is rested on the inspection line B (time t2). When the connecting rods CR are rested on the inspection lines A and B, respectively, the connecting rod of the inspection line A, as shown in FIG. 6B, is first conveyed (time t3) and subjected to weight measurement in the process P2 (time t4). While the weight measurement is being conducted on the inspection line A, the connecting rod CR of the inspection line B starts to be conveyed (time t5) with a certain time lag with respect to time t3, at which conveyance of the connecting rod CR of the inspection line A starts. Weight measurement is going to start to be conducted on the inspection line B. When the connecting rods CR are conveyed from the process P1 to the process P2, the unit 11 loads new connecting rods CR for the inspection lines A and B one after another.

When the weight measurement in the inspection line A is finished during the weight measurement (process P2) in the inspection line B, another conveyance is conducted on the inspection line A (time t6). Subsequently, measurement of inner diameter for the connecting rod CR is started in the process P3 (time t7). When the weight measurement in the inspection line B is finished during this measurement of inner diameter in the inspection line A, the connecting rod CR of the inspection line B is conveyed to the process P3 (time t8).

When the measurement of inner diameter in the inspection line A is finished, the unit U including the unit 13 for measuring inner diameter and the unit 14 for measuring pitch moves to the inspection line B (time t9). In this way, the measurement of inner diameter in the inspection line B is going to start to be conducted (time t10). It should be noted that because movement of the unit U is conducted after completion of the measurement of inner diameter (process P3) and before completion of the weight measurement (process P2) in the inspection line A, it is possible to efficiently spend time in waiting for the completion of the weight measurement. When the weight measurement in the inspection line A is finished during the measurement of inner diameter in the inspection line B, another conveyance is conducted in the inspection line A (time t11).

When the measurement of inner diameter is finished in the inspection line B, the unit U is moved to the inspection line A (time t12), where measurement of pitch for the connecting rod CR is conducted (time t13). At this time, measurement of inner diameter is simultaneously conducted. When the weight measurement in the inspection line B is finished during the pitch measurement in the inspection line A, another conveyance is conducted in the inspection line B (time t14). Afterward, the unit U is commonly used between the inspection lines A and B by repeating operation shown in FIGS. 6D and 6E. After pitch measurement, inspection for inserting a pin is conducted in the process P5, removal of works with defects is conducted in the process P6 (see FIG. 2) and marking and the like are conducted in the processes P7 to P9 (see FIG. 3). In this way, the inspections have come to completion.

The embodiment of the present invention described above provides following advantages.

Because a connecting rod CR carried by the conveyor unit 4 sequentially undergoes inspections one after another conducted by the unit 12 for measuring weight, the unit 13 for measuring inner diameter, the unit 14 for measuring pitch and the unit 15 for inserting pin, which results in an intensive line of inspection processes, it is possible to reduce the time required for inspecting the connecting rod CR. Furthermore, the units 13 and 14, which are commonly used by the inspection lines A and B by introducing the transferring unit 2 which shuttles the units 13 and 14 between the inspection lines A and B, enables a reduction in manufacturing costs.

While a connecting rod CR is undergoing weight measurement conducted by the unit 12, the units 13 and 14 are transferred to one of the inspection lines A and B so that they are used on it. In this way, it is possible not only to efficiently spend time in waiting completion of the process conducted by the unit 12 for measuring weight, but also to reduce manufacturing costs.

Because the actual component (pin) is inserted into the small-end hole of the connecting rod CR, it is possible not only to remove burrs, but also to provide a strict inspection, which verifies whether or not the actual component surely fits into the small-end hole. This results in an increase in accuracy of quality and inspection accuracy of a work.

Since there is a difference in timing of conveyance between the inspection lines, it is possible to decrease tact time for conveyance so as to increase a rate of operation for the apparatus 1 for inspecting conveyed works. More specifically speaking, it is explained as follows. If timing of conveyance is synchronized between the inspection lines A and B, it is necessary that consecutive operation including inspection (processes P2 and P3)→transfer of the unit U→inspection (processes P2 and P3) should be conducted while conveyance is not conducted. In contrast, when timing of conveyance is shifted as in the present embodiment, number of the inspection (processes P2 and P3) is reduced to one because transfer of the unit U can be conducted in parallel with conveyance of a work. In this way, the tact time for conveyance can be decreased according to situations.

It will now be appreciated from the foregoing description that the present invention is not limited to the particularly illustrated embodiment discussed above and may be carried out in various modified forms.

Although the embodiment described above has two units (the unit 13 for measuring inner diameter and the unit 14 for measuring pitch) which are transferred in unison, the present invention is not limited to this. It may be alternatively possible that the two units are transferred separately from each other. Furthermore, it may be possible to transfer only one unit or three units or more.

In the embodiment described above, the timing of conveyance is shifted between the inspection lines. The present invention is not limited to this example, but it may be possible that the timing is synchronized. When synchronized, it may be preferable, but not necessarily, that during completion of conveyance to starting of a subsequent conveyance, processes are sequentially conducted in the following manner: inspection (processes P2 and P3) first in the inspection line A→transfer of the unit U→inspection (processes P2 and P3) in the inspection line B. After this sequential operation, it may also be preferable, but not necessarily, that processes are sequentially conducted first in the inspection line B, where the unit U currently resides, in the following manner: inspection→transfer→inspection in the inspection line A. The reason for this sequential operation is that because the number of transfer of the unit U can be reduced, it is possible to decrease power consumption.

It may be alternatively possible to transfer the unit U among three or more inspection lines. For example, when a most time-consuming inspection unit requires a larger amount of time and less time-consuming inspection units require a smaller amount of time, it may be possible to use the less time-consuming inspection units in such a sequence as inspection→transfer→inspection→transfer→inspection . . . among three or more inspection lines during inspection conducted by the most time-consuming inspection unit.

Foreign priority document, JP2005-223459 filed on Aug. 1, 2005 is hereby incorporated by reference.

What is claimed is:

1. An apparatus for inspecting conveyed works comprising:
a plurality of inspection lines, each line comprising plural kinds of inspection units and a conveyor unit configured to convey the works to each inspection unit one after another,
wherein certain inspection units are commonly used by the inspection lines.

2. An apparatus according to claim 1 further comprising a transfer unit, wherein while an inspection is being conducted by a most time-consuming inspection unit, the transfer unit carries less time-consuming inspection units, each requiring a shorter period of time for inspection than the most time-consuming inspection unit, to each inspection line so that the certain inspection units are commonly used by the inspection lines.

3. An apparatus according to claim 2, wherein the works are connecting rods, the most time-consuming inspection unit is a unit for measuring weight of each connecting rod and the less time-consuming inspection units are a unit for measuring inner diameters of a big-end hole and a small-end hole of each connecting rod and a unit for measuring pitches of the big-end hole and the small-end hole.

4. An apparatus according to claim 3, further comprising for each inspecting line a unit for inserting pin which inserts an attachment component into the small-end hole so as to remove burrs thereof and verifies a fitting condition between the small-end hole and the attachment component.
